(19) United States
(12) Patent Application Publication
(10) Pub. No.: US 2012/0087482 A1
(43) Pub. Date: Apr. 12, 2012

(54) Method Of Providing An Emergency Call Center

(76) Inventor: Robert L. Alexander, SR., Mitchellville, MD (US)

(21) Appl. No.: 13/317,354

(22) Filed: Oct. 11, 2011

Related U.S. Application Data
(60) Provisional application No. 61/391,810, filed on Oct. 11, 2010.

(51) Int. Cl. H04M 11/04

(52) U.S. Cl. 379/45

(57) ABSTRACT

Once an emergency button is activated, a signal would go directly to an emergency call center. A worker at the call center will identify via a GPS program, the exact location of the call, and immediately search out the nearest 911 operator. The call center operator will instantly connect to the 911 operator and stay of the call. The emergency call center will become a back up for the 911 system by recording in both speech and text. The user is not required to dial 911, and may use voice activation, which removes the physical input action required to call for assistance and location information while under attack or other distress. In addition, images of the emergency situation are automatically submitted to a security-monitoring agency.

### CROSS REFERENCE TO RELATED APPLICATION

This application is based upon and claims benefit of copending and co-owned U.S. Provisional Patent Application Ser. No. 61/391,810 entitled “Method of Providing an Emergency Call Center”, filed with the U.S. Patent and Trademark Office on Oct. 11, 2010 by the inventor herein, the specification of which is incorporated herein by reference.

### BACKGROUND OF THE INVENTION

### Field of the Invention

This invention relates to personal safety and communication networks and, more particularly, to a call center to assist in gathering evidence and providing information in the event of a personal emergency.

### BACKGROUND

In 2004, the U.S. Department of Justice (DOJ), Bureau of Justice Statistics (BJS) reported that 5,183,000 violent crimes were committed, such as rape, sexual assault, robbery, aggravated and simple assault. For the same year, 220,000 additional cases listed as personal theft, such as purse snatching and pick pocketing were reported for a total of 5.4 million crimes against individual victims! As integrated circuit chips become faster and smaller in mobile devices, security solutions designed to prevent and mitigate personal attacks will be required and demanded by the mobile phone user population.

Holding a camera at the right place and at the right time can save lives, deter crime, help prosecute convictions, and enhance public safety. In this respect, the U.S. Department of Justice (DOJ) in 2004 estimated that more than 6 million citizens, increasing annually, were confronted with the incidence of fear and personal assault; many of whom were walking and talking on a cell phone or using a listening device. Whereas crime has become so pervasive in our global environment, it is further estimated that a vast majority of people, cell phone users as well, have a grave sense of fear and apprehension for their personal safety and security while walking and talking. The market and need for a public safety and security device are evident.

### SUMMARY OF THE INVENTION

A primary novelty of this invention is on demand help in the event of a physical assault. The user is not required to dial 911, and may use voice activation, which removes the physical input action required to call for assistance and location information while under attack or other distress. In addition, images of the emergency situation are automatically submitted to a security-monitoring agency.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a flow chart showing a communication network for an emergency call center according to a first embodiment of the present invention, and

FIG. 2 illustrates emergency scenarios for the call center according to a first embodiment of the present invention.

### DETAILED DESCRIPTION OF EXEMPLARY EMBODIMENTS

The invention summarized above may be understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The emergency call center of the present invention is designed to enable users with specially equipped phones to prevent, capture, and report personal threats such as robbery, kidnapping, and rape in real time. In the below description of the invention, 911 Rescue Me is the name of the interactive system and call center.

The Call Center Provisions for the 911 Rescue Me Application software will include voice recognition and GPS tracking with wireless ACE National Security Alerts to be received or sent via text messages or voice messages on your cell phone. Amber Alerts may also be included as an encompassing part of the ACE comprehensive alert system, described below. ACE National Security Alert is the adult version of Amber Alert and may be considered Amber Alert's Big Brother—the Big Daddy of all emergency cellular mobile alert systems.

I. Provisions for ACE National Security Alert (ACE-NSA) Sent to Call Centers by Cell Phone Subscribers

The Call Center will be equipped to receive ACE National Security Alerts from citizen subscribers as follows; thereby putting millions of eyes or eyewitnesses to potential terrorist plots in progress sent from 911 Rescue Me application users. Cutting-edge technology and voice recognition will distinguish the nature of the call as a crime, medical emergency, or national security alert (NSA). In the event of a NSA call, the Call Center will immediately forward the call to Homeland Security and FBI by relaying the impending terrorist plot or unfolding activity in real-time video feed to authorities. The 911 Rescue Me application user will be instructed to use code words NSA or TATTOO Alert—Teaming up Against Terrorists 2 Take'em On and Out Alert.

II. Provisions for ACE National Security Alert (ACE-NSA) Sent from Call Center by Cell Phone Subscribers

Utilizing the effective technology available through the research and development of the design features associated with the development of the software for 911 Rescue Me application, the Call Center features will include the following provisions for federal agencies to submit emergency alerts.
1. National Security/Homeland Security Alert capabilities to notify all subscribers of impending national security alerts, by regional localities or nationally.
2. National Emergency Disaster Alert and Emergency Preparedness Alert for various localities and municipalities to be sent to cell phones located in various GPS locations during times of natural disaster for area alerts or national weather alerts.
3. National Defense Alert for DoD and National Guard “troop call up” notifications to military personnel on this system to receive immediate emergency notices.
4. Public Health Crisis and Early Warning Emergency Alerts for pandemics and other health alerts, including provisions for global alerts from the World Health Organization.
5. Public Safety and Law Enforcement National and Global Crime Emergency Alerts for public watch for individuals deemed to be most dangerous to public safety: (a) FBI's top five most wanted; (b) Interpol's top five most wanted. This collective top 10 may be posted by law enforcement weekly or bi-monthly on what will be known as “Fugitive Fridays.”
6. University/College Campus Alerts: The nation's 4,250 colleges and universities' campus police are charged with the daunting task and responsibility for providing security and protection for the estimated 25 million college students. Since the Virginia Tech massacre, there has been a dramatic concern about alerting students of impending campus violence. The ACE National Security Alert Call Center will augment existing campus communication alerts and possibly route campus security alerts to concerned parents of college students, who are registered in the system.

### Security Alert Process Flow

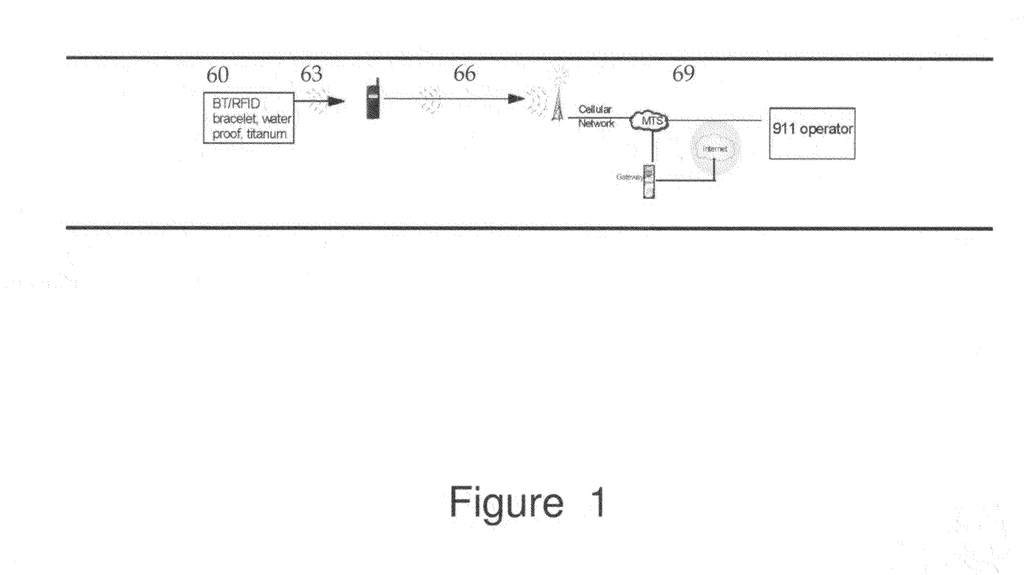

Referring to FIG. 1, the security alert process flow is illustrated.

60) A victim under attack presses a device (Bluetooth jewelry, key fob, etc.) (NOTE: The panic message can also be initiated by directly pressing an emergency button on the phone.)

63) Bluetooth (RFID, IrDA) chip embedded in the device (watch, key fob) sends a message to Bluetooth (RFID, IrDA) enabled phone. Operation of the phone can initiate operation of the phone's camera to capture images.

66) Phone automatically contacts a call center operator 42 dependent on configuration. Images, data, and mobile location information coordinates are automatically sent via the wireless service provider.

69) Call center operator contacts local 911 operator who dispatches police officers or other emergency responder to location of the emergency.

Once an emergency button is activated, the signal would go directly to an emergency call center. A worker at the call center will identify via a GPS program, the exact location of the call, and immediately search out the nearest 911 operator. The call center operator will instantly connect to the 911 operator and stay of the call. The emergency call center will become a back up for the 911 system by recording in both speech and text.

The emergency call center will be able to record the pictures or video generated by activating the emergency signal on the phone. These recordings can also be forwarded to the 911 operator if they are able to receive them. The emergency call center may have visual recognition software that can look at the pictures and/or video and assist in identifying what emergency services may be required.

In a preferred embodiment, after connecting to the 911 system, the emergency call center may contact predetermined family and/or friends to report that the user is involved in an emergency situation. Additionally, the call center will assist the 911 operator by forwarding all personal information previously established by the telephone carrier network and the user at time of set up. Such information may include, but not be limited to, name, address, blood type, medical conditions, etc.

### Report (Real-Time):

A 911 direct dial feature automatically calls for emergency assistance first responders. In some embodiments, the 911 call can be automatically initiated by pressing an emergency button.

### Capture:

The phone includes a camera that automatically captures a (video/image) of the perpetrator when the emergency button is pressed and held.

The emergency button automatically initiates contact to a security-monitoring center. In addition, images and/or video of the attacker are sent to a Wireless Network Operator or Security Monitoring partner (discussed in more detail below) and a message is sent to a police station to dispatch police officers.

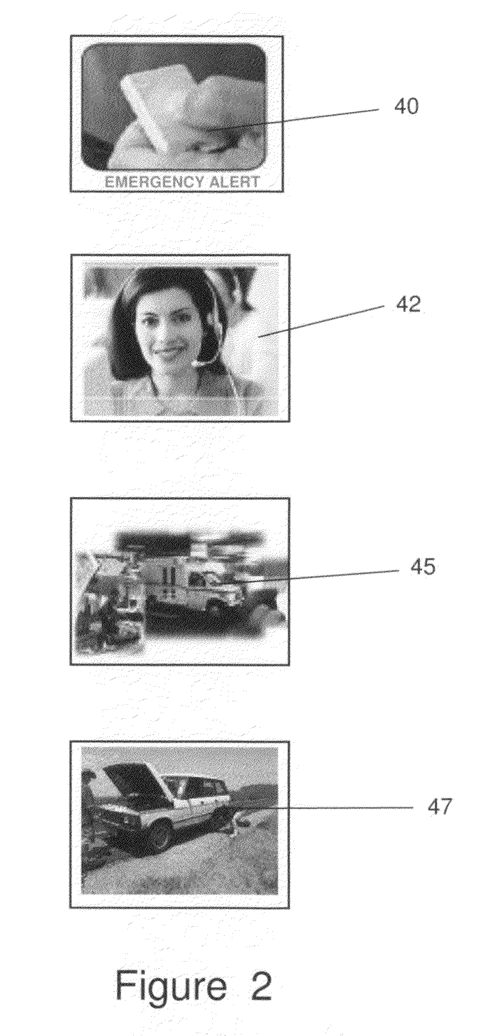

In a preferred embodiment, the phone will be wirelessly connected to a remote activator button 40, as shown in FIG. 2. The remote activator button 40 can initiate several functions. For example:
The remote activator button 40 can initiate a pre-set text message that will activate the phone remotely, within approximately 100 feet, and automatically contact a monitoring call center operator 42 for prompt, appropriate emergency response.
Emergency call center operator will immediately respond to coded pre-set text messages from the remote activator button 40 and relay to 911 (police, fire, paramedics) 45 in the local area and immediately follow-up by contacting selected relatives or neighbors listed by the user. As an example, coded pre-set text messages may include:
   #1—Press the remote activator button 40 once to signal the phone to call an emergency call center operator 42.
   #2—Press the remote activator button 40 twice to signal hostage distress.
   #3—Press the remote activator button 40 three times to signal distress for fire or medical emergencies 45, such as falling, strokes, seizures, heart attacks and other life threatening injuries/emergencies.
   #4—Press the remote activator button 40 four times to signal for non-medical/non-life threatening emergencies, such as stranded vehicles 47.
Emergency assistance may be readily accessed by pressing the remote activator button 40 for other life threatening emergencies/injuries to those who are unable to activate the phone in the case of fire, falls resulting in bone or hip fractures, strokes or seizures, heart attacks, and similar medical emergencies.

### Remote Alarm Device

In a preferred embodiment, the phone uses a Bluetooth®, IrDA, or RFID enabled device that can be hidden in a watch, key chain, or jewelry to remotely control the phone and remotely engage the emergency button. In a scenario where the victim is leaving a building and the phone is tucked away in a pocketbook, a device can initialize the phone to call for help, if the victim were attacked. In a scenario where a victim is attacked while walking to a car or train and the phone is in a coat pocket or pocketbook, the phone is designed to pair up and communicate via wireless communications with the device. The device will send a panic signal to the phone when the phone is accessible to the victim (in coat pocket, etc). The device utilizes short-range wireless technology to communicate with the phone to initiate the alerts described above back to the wireless network operator 42. The device can be designed inside of a piece of jewelry (Bluetooth® watch, necklace/pendant, bracelet . . . ), or a wireless key lock remote.

### Location Positioning Technology

In a preferred embodiment, the phone uses existing GPS Global Positioning Satellite capability and/or Wireless Access Protocol (WAP) location services. Both technologies enable a mobile phone to be located and tracked by police.

The wireless E911 program requires carriers, upon appropriate request by a local Public Safety Answering Point (PSAP), to report the telephone number of a wireless 911 caller and the location of the antenna that received the call. The program requires wireless carriers to provide precise location information, within 50 to 300 meters in most cases.

The WAP location services required are self-positioning and tracking. Using the existing Wireless E911 and rescue service, emergency responders can locate and rescue a user with a subscribed phone who is under attack. If the subscriber has been hijacked and forced into a car trunk or otherwise detained, emergency responders can employ the WAP tracking service to track the victim's location.

In the event the subscriber is experiencing a health related emergency, such as a heart attack, the phone can employ the WAP Health Monitoring service.

The technology for the phone used to send video and digital photos from the crime scene by the user to the call center operator and forwarded elsewhere as required can also be used in the following specific devices:
1. Crime Scene Camera—video and digital camera technology above will be mounted on a tripod at the crime scene and make on-going video scans of the crime scene with multiple digital photos sent back to the call center and forwarded directly to police homicide investigators who will be able to monitor the crime scene and multiple crime scenes at one time from the police headquarters.
2. Constable (COP) Surveillance Cam—video and digital camera technology above will be mounted on a round device resembling a pocket watch and suspended around the neck by a chain adjacent to the chest area of all police officers, similar to the manner detectives customarily wear their badges when not in uniform. This will enable the officer to take digital photos and video scanning to his or her front as they patrol. When worn by police officers and turned to the “ON” position, similar to the video in police cruisers, individual officers will be able to capture activities as they make routine traffic stops or make contact with a potential criminal. Video and digital camera photos will be sent back routinely to the call center and forwarded onto the local police supervisor to monitor, if so desired, the police contact with the public, while on patrol. This device will assist police officers, their supervisors, and the general public, much the same as the surveillance cameras in the cruisers, to provide an accurate account of the officer's contact with the public, whether a routine traffic stop or a crime scene.

As a further feature of the present invention, a website will accompany the product with the additional feature of crime phone photos/videos taken by phone users of suspect assailants during the commission of a crime. These crime scene photos will be sent to the 911 Call Center operator as evidence for criminal prosecution. The images will become public information, and once received by the 911 Call Center, they will be forwarded on to the website for public viewing.

The website will chronicle time and date of all crime photos, videos, and 911 recordings sent to the 911 Call Center categorized by zip code/community of the crime scene location identified by GPS. The public will be encouraged to log on and call in to identify suspected assailants to help solve crime in their respective neighborhoods and communities. Videos and digital photos will be shown on the website and will be made available to existing programs that profile criminal activity, such as Court TV's Video Justice and Comcast's Fugitive Files for use at their discretion.

The invention has been described with references to a preferred embodiment. While specific values, relationships, materials, and steps have been set forth for purposes of describing concepts of the invention, it will be appreciated by persons skilled in the art that numerous variations and/or modifications may be made to the invention as shown without departing from the spirit or scope of the basic concepts and operating principles of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A personal safety and communication network (Call Center) that assists in the gathering of evidence/imagery and providing information to authorities and others in the event of a personal emergency
